(19) United States
(12) Patent Application Publication
(10) Pub. No.: US 2009/0178280 A1
(43) Pub. Date: Jul. 16, 2009

(54) METHOD FOR RECONDITIONING A USED GRINDING ROLL

(76) Inventors: Norbert Patzelt, Beckum (DE); Herbert Pingel, Wadersloh (DE); Johann Knecht, Wadersloh (DE)

Correspondence Address: STITES & HARBISON PLLC, 1199 NORTH FAIRFAX STREET, SUITE 900, ALEXANDRIA, VA, 22314, US

(21) Appl. No.: 12/305,510

(22) PCT Filed: May 23, 2007
(86) PCT No.: PCT/EP2007/004597

§ 371 Date: Dec. 18, 2008

(30) Foreign Application Priority Data
Jun. 21, 2006 (DE) 10 2006 028 546.8

(51) Int. Cl. B23P 6/00

(52) U.S. Cl. 29/895.1

(57) ABSTRACT

The invention relates to a method for reconditioning a used grinding roll of a high-pressure bed grinding mill. In said method, the surface of the rolling body is turned by a certain degree after removing the worn profiled members, whereupon the existing bores can be deepened to a depth that is sufficient for receiving new profiled members or new bores can be created according to a new bore pattern. New profiled members are then inserted into the bores. The inventive method allows a used grinding roll to be reconditioned in a particularly time-saving manner while economizing material.

The invention relates to a method for reconditioning a used grinding roller of a high-pressure material bed roller mill in accordance with the preamble of claim 1 and a grinding roller of a high-pressure material bed roller mill in accordance with the preamble of claim 4.

Grinding rollers of this type are known, for example, from EP0516952B1. They contain a plurality of wear-resistant profile-members which are embedded, with a portion of the length thereof, in holes of the roller body and, with the remainder of the length thereof, project above the surface of the roller body. When such rollers are operated, the intermediate spaces between the projecting profile-members are filled with the material to be comminuted which is supplied to the material bed roller mill and which therefore produces a given autogenous wear protection for the surface of the roller body.

Nevertheless, over the time spent in operation, both the projecting profile-members and the surface of the roller body are subject to unavoidable wear.

DE19618143A1 further discloses a grinding roller in which the hardness of the material of the roller body forming the roller surface is greater than 56 HRC (Rockwell Hardness). That grinding roller is used in comminution operation until a substantial portion of all the profile-members is completely worn and/or has fallen out of the roller body. The reconditioning of the used grinding roller is then carried out in such a manner that the roller surface has its cylindrical shape conferred on it again by the profile-members and the original holes being completely turned, after which new holes are produced and new profile-members are introduced into those holes.

Although it is possible for the surface to wear substantially only to the same extent as the projecting profile-members by using an extraordinarily hard base material for the surface of the roller body, the complete turning of the surface of the roller body provided with holes involves substantial complexity owing to the great hardness of the surface material when a used grinding roller of this type is reconditioned.

Therefore, the problem addressed by the invention is to configure a method in accordance with the preamble of claim 1 in such a manner that it is possible to recondition a used grinding roller in a particularly economical manner in terms of time and materials and therefore cost.

This problem is solved according to the invention by the characterising features of claim 1. The dependent claims relate to advantageous developments of the invention.

A grinding roller which is intended to be reconditioned in accordance with the method according to the invention is not (unlike the grinding roller according to DE19618143A1) used in comminution operation until a substantial portion of all the profile-members is completely worn and/or has fallen out of the roller body. Instead, the reconditioning is already carried out at a time before the surface of the roller body has worn as far as a location near the base of the hole provided. It is thereby possible not to turn the surface of the roller body completely by a dimension corresponding to the depth of the original holes, but instead to carry out a partial material removal (at least in the particularly worn part-region of the width of the roller body) only as far as a diameter which is greater than the diameter of the base of the holes provided. That partial turning of the worn surface of the roller body is facilitated according to the invention in that the surface of the roller body (unlike in the solution according to DE19618143A1) has a level of hardness which is lower than that of the projecting profile-members.

In order to provide the roller body which is regenerated in this manner with projecting profile-members again, it is possible according to the invention for:

a) the holes provided to be extended as far as a depth which is sufficient to receive new profile-members,

b) new holes to be produced in accordance with a new hole configuration,

c) and/or shorter profile-members to be introduced into the holes which are now shorter.

Since the surface of the roller body has a different state of wear in many instances in individual part-regions (for instance, at the centre and at the edges of the width of the roller body), it may be advantageous in the individual case to combine together the three above-mentioned variants for providing the roller body with profile-members again.

In all cases, the solution according to the invention results in reconditioning of a used grinding roller which is very economical in terms of time and materials and therefore cost.

A number of embodiments of the invention are illustrated in the drawings.

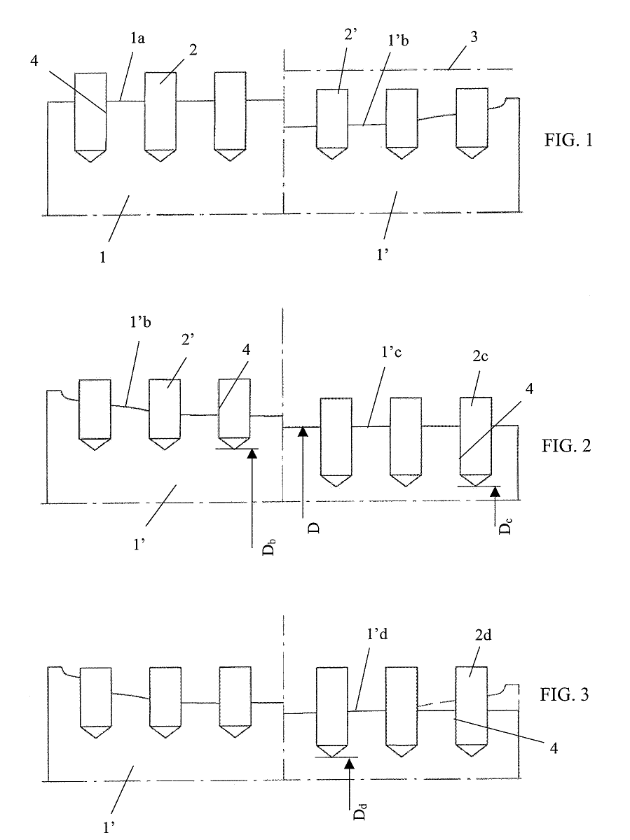

FIG. 1 shows (as a schematic partial longitudinal section through the roller) the new state of the roller on the left. The roller body 1 is provided with a plurality of holes 4, in which profile-members 2 are embedded with a portion of their length, whereas they project with the remainder of their length above the surface 1a of the roller body 1.

FIG. 1 shows the worn state after a given operating time on the right. The surface 1′b of the roller body 1′ is removed to a greater or lesser extent—to different degrees in the individual regions. Similarly, the profile-members 2′ are now shortened owing to the wear with respect to the original length (height line 3).

FIG. 2 shows how a used grinding roller can be reconditioned, for example, according to the method according to the invention. On the left, the worn state of the roller body 1′ and the profile-members 2′ is illustrated. First, the worn profile-members 2′ are removed for reprocessing. Subsequently, the worn surface 1′b of the roller body 1′ is turned as far as a diameter D. That diameter D is greater than the diameter D_{b} of the base of the holes 4 provided. The new surface is designated 1′c. Subsequently, new holes 4 are produced and new profile-members 2c are introduced.

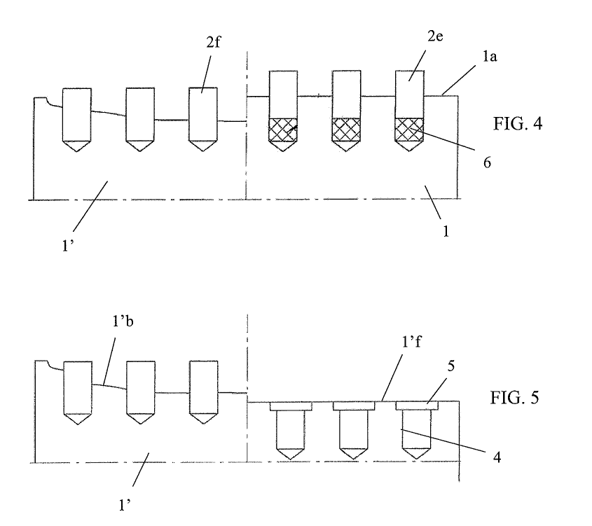

In a manner different from the method described above, it is also possible according to the invention to turn the worn surface of the roller body only partially (that is to say, in individual surface regions) or by a smaller dimension and to extend the holes provided to such a depth (new diameter D_{c}) that new profile-members 2c can be introduced. In the case of FIG. 3, it is assumed in this respect that the roller body 1′ has a wear state in which it is sufficient, for reconditioning, for the surface to be turned only partially, particularly only in individual surface regions (for instance, in the peripheral region indicated on the right in FIG. 3 with a broken line). This results in a new surface 1′d. Subsequently, the holes 4 provided are extended to such a depth (that is to say, as far as the new diameter D_{d}) that new profile-members 2d can be introduced. When FIGS. 2 and 3 are compared, it is apparent that, in the case of FIG. 3, the new profile-members 2d are not anchored quite so deeply in the roller body as the new profile-members 2c are in the case of FIG. 2. The solution of FIG. 3 has the advantage that a greater amount of removable material of the roller body is available for any further reconditioning of the roller. On the other hand, the solution of FIG. 2 has the advantage that it allows a longer operating time of the roller until the next reconditioning operation owing to the deeper anchoring of the new profile-members introduced during the first reconditioning operation.

The new state of the roller is illustrated on the right in the other embodiment illustrated in FIG. 4. In this instance, shorter profile-members 2e are located on a spacer or pressure mass 6 which is itself supported on the base of the hole 4 and which acts as a longitudinal compensation means. If the roller body 1′ is worn after a given operating time, as illustrated on the left in FIG. 4, new profile-members 2f can be introduced after the spacer or pressure mass 6 has been removed without any need to extend the holes 4. However, it is also possible to extend the holes slightly at the same time as the spacer or pressure mass is removed.

In the embodiment of FIG. 4, consequently, the holes 4 have, in the new state of the grinding roller (on the right in FIG. 4), a depth which is greater than the minimum depth necessary for securely retaining profile-members. The “excess depth” is taken up by the spacer or pressure mass 6 up to the time of the first reconditioning operation. After the first reconditioning operation and after the spacer or pressure mass has been removed, the holes 4 then have precisely the minimum depth which is sufficient to securely retain the profile-members (on the left in FIG. 4).

Finally, FIG. 5 illustrates a variant in which the surface 1′b is first turned at least in a part-region of the width of the roller body in order to recondition the worn roller body 1′ so that a new cylindrical surface 1′f is produced. Subsequently, the holes 4 which are still present but which are in many instances slightly damaged in the opening region owing to the worn profile-members being removed are first provided with a counter-sinking 5 in order to ensure correct centring of the drill for the subsequent drilling of the holes 4. The holes 4 are subsequently extended by a subsequent drilling operation in order to retain new profile-members (which are not illustrated in FIG. 5).

1. Method for reconditioning a used grinding roller of a high-pressure material bed roller mill, containing a plurality of profile-members which are embedded in holes of the roller body with a portion of the length thereof and, with the remainder of the length thereof, project above the surface of the roller body, the profile-members having greater hardness than the surface of the roller body and the projecting portion of the profile-members and the surface of the roller body being at least partially worn,
characterized in that, after the worn profile-members have been removed, the worn surface of the roller body is turned at least in a part-region of the width of the roller body as far as a diameter which is greater than the diameter of the base of the holes provided, after which
a) the holes provided are extended as far as a depth which is sufficient to receive new profile-members,
b) and/or new holes are produced in accordance with a new hole configuration,
c) and/or shorter profile-members are introduced into the holes which are now shorter.

2. Method according to claim 1, characterized in that, after the worn surface has been turned, shorter profile-members and a spacer mass which is supported on the hole base and which acts as a longitudinal compensation means are introduced into the holes which are now shorter.

3. Method according to claim 1, characterized in that, before the holes are extended, counter-sinking of the holes is carried out.

4. Grinding roller of a high-pressure material bed roller mill, containing a plurality of profile-members which are embedded in holes of the roller body with a portion of the length thereof and, with the remainder of the length thereof, project above the surface of the roller body,
characterized in that
a) the holes have, in the new state of the grinding roller, a depth which is substantially greater than the minimum depth necessary for securely retaining profile-members, with the space between the profile-members and the base of the holes being filled by a spacer or pressure mass until the first reconditioning of the grinding roller,
b) and in that, in the reconditioned state of the worn roller body, the spacer or pressure mass is removed and new profile-members are introduced into the holes.
